(19) United States
(12) Patent Application Publication
(10) Pub. No.: US 2024/0220002 A1
(43) Pub. Date: Jul. 4, 2024

(54) A SYSTEM AND A METHOD FOR NON-VERBAL COMMUNICATION

(71) Applicant: DICO TECHNOLOGIES S.R.L., Milano (IT)

(72) Inventor: Giacomo BELLANI, Carate Brianza (Monza-Brianza) (IT)

(21) Appl. No.: 18/558,306

(22) PCT Filed: May 6, 2022
(86) PCT No.: PCT/IB2022/054194

§ 371 Date: Oct. 31, 2023

(30) Foreign Application Priority Data
May 21, 2021 (IT) 102021000013235

(51) Int. Cl. G06F 3/01; G06F 3/04842; G06F 40/166

(52) U.S. Cl. CPC G06F 3/011; G06F 3/017; G06F 3/04842; G06F 40/166

(57) ABSTRACT

A computer-executable method for non-verbal communication is performed by mapping at least one non-verbal action of a user uniquely associating it with a corresponding communication parameter. Subsequently, a text content comprising at least one text element that can be selected is delivered to the user via a graphical interface and during this delivery the non-verbal actions of the user are continuously acquired. The at least one text element is then processed according to the communication parameters uniquely associated with the acquired non-verbal actions.

The present invention relates to the technical field of communication systems and methods.

In particular, the present invention relates to a system and a method for non-verbal communication which is particularly advantageous in the field of medical/nursing care for patients unable to express themselves verbally, for example intubated or tracheostomized patients.

The ability to communicate effectively with other people is a fundamental need for every individual.

However, impediments can occur in a wide range of contexts, which make such a communication process difficult, if not impossible, thus creating considerable inconvenience.

By way of example, particular reference is made to the medical field in which a hospitalized person, or a person subjected to certain medical procedures and/or therapeutic treatments, may find it impossible to express himself/herself verbally with the people around him/her and specifically with the medical staff.

Think of ICU patients who may be intubated or tracheostomized and therefore unable to speak.

In this context, it is even more evident the need to have methods and systems which allow the patient to communicate not only to express basic needs, but more importantly, also to alert the medical staff of the potential onset of specific problems for which the activation of an simple alarm would not be sufficiently understandable/interpretable.

For this purpose, there are devices that can receive non-verbal inputs and turn them into messages through which the patient communicates with other people.

However, known devices still have disadvantages and inefficiencies that make their implementation unsatisfactory and their use not easy for the user.

In particular, known devices are extremely inflexible in their operation, therefore not adaptable to the specific needs of the individual patients, as they are configured for uniquely identifying a single specific non-verbal action which, in turn, is uniquely associated with a single type of message.

Therefore, if the patient is unable to carry out or has difficulty in carrying out the specific and unique non-verbal action identifiable by the device, the latter is in fact useless and unusable.

In this context, the technical task underlying the present invention is to propose a system and a related method for non-verbal communication which overcome at least some of the above-mentioned drawbacks of the prior art.

In particular, it is an object of the present invention to provide a system and a method which can allow a person who is unable to express himself/herself verbally or has difficulty in doing so, in particular an intubated or tracheostomized patient, to communicate non-verbally with a second person in a particularly versatile manner that is also precise and efficient at the same time.

The specified technical task and objects are substantially achieved by means of a system and a method comprising the technical features set forth in one or more of the accompanying claims.

According to the present invention, a method for non-verbal communication, particularly a computer-executable method, is shown herein.

The method comprises mapping at least one non-verbal action of a user uniquely associating it with a corresponding communication parameter.

Once the mapping step is completed, resulting in unique association between actions and respective parameters, a text content is delivered to the user.

In particular, the text content is delivered via a graphical interface.

Furthermore, the text content comprises at least one text element that can be selected.

Such a text element, for example, can comprise one or more alphanumeric characters, symbols, words, phrases, graphic elements.

During the text content delivery, the non-verbal actions of the user are continuously acquired, and the text content is processed according to the communication parameters uniquely associated with the progressively acquired non-verbal actions.

Advantageously, the method proposed herein is applicable to a wide range of situations since it is not bound to the detection of pre-specified non-verbal actions but can be easily adapted to each user thanks to the mapping procedure, as it is possible to match the communication parameters to the actions that can be carried out more easily and more readily by the user.

It is also an object of the present invention to provide a system for carrying out the above-mentioned method.

In particular, the system comprises a processing unit designed to control the execution of the above-identified steps (mapping, text content delivery, acquisition of non-verbal actions).

The system further comprises a graphical interface which can display at least the text content to be delivered to the user.

There is also at least one sensor which can be associated with at least one part of the user's body for the acquisition of his/her non-verbal actions.

The dependent claims, hereby incorporated by reference, correspond to different embodiments of the invention.

Further features and advantages of the present invention will become more apparent from the following description of a preferred, but not exclusive, embodiment of a method and a system for non-verbal communication.

The term non-verbal communication is intended to mean a type of communication comprising all aspects of a communicative exchange in which at least one of the individuals involved is enabled to transmit a message or informative content without the need to speak or emit sounds.

In particular, the present method can be executed by a computer, i.e., the execution of the steps making up the method as a whole is controlled and managed by one or more computer resources capable of storing and executing the instructions necessary to implement the method by controlling one or more peripherals.

Operatively, the execution of the method comprises an initial mapping step in which at least one non-verbal action of a user is uniquely associated with a communication parameter.

In other words, a unique association is generated between non-verbal actions executable by the user and respective distinct communication parameters.

In general, the term “non-verbal action” is intended to indicate any action that the user can execute and that is detectable by a sensor which does not require the user to speak or emit sounds.

Advantageously, the mapping operation allows the actions that are more easily executable by the user to be associated with specific parameters through which the user can communicate.

In other words, the operation of the method can be calibrated according to the specific requirements and abilities of the user; even if these requirements and abilities should change, for example due to an evolution of the clinical situation, it is sufficient to re-map the communication parameters and rapidly adapt them to the new conditions of the user to ensure the correct and efficient execution of the method.

Moreover, the mapping procedure allows the user to gradually learn how the method works, putting him/her in the condition of personally calibrating its operation.

Once the mapping has been carried out, i.e., the correspondence between a non-verbal action and a specific communication parameter has been clearly and precisely defined, a text content comprising at least one selectable text element is delivered to the user.

The user is then provided with, for example by displaying it on a graphical interface, a text content which comprises portions (the at least one text element) that can be selected by the user to compose a message that can be received by a second person, for example a member of the medical staff taking care of the user, or transmitted, for example, by e-mail.

In greater detail, the composition of the message is obtained by continuously acquiring, during the delivery of the text content, the non-verbal actions executed by the user.

The text content, specifically the at least one text element, is then processed according to the communication parameters uniquely associated with the acquired non-verbal actions.

In other words, the execution of non-verbal actions allows the user to interact with the text content by operatively selecting the individual text elements for the composition of a message.

These text elements can comprise at least one of: alphanumeric characters, symbols, words, phrases, graphic elements, thus providing a wide range of contents that the user can select, allowing him/her to communicate in an articulated, precise and complete way.

In greater detail, the mapping operation is executed by means of a training procedure selected from a plurality of possible distinct procedures.

In other words, the method comprises the implementation of distinct and different training procedures, and the mapping step comprises the execution of a specific training procedure selected from those available.

Specifically, each training procedure allows the distinct and specific communication parameters to be uniquely associated with a specific condition of immobility and/or movement of at least one part of the user's body.

Therefore, the mapping can be carried out by selecting from among different possibilities the training procedure that is most appropriate and suitable for the specific needs and motor abilities/possibilities of the user.

Operatively, the training procedure that can be selected comprises monitoring the body part that is more easily movable by the user (a hand, a finger, a foot, a shoulder . . . ) and associating the movements/immobility of such a specific part with respective communication parameters.

The movement of the body part can be acquired with a level of detail that is functional to the specific training procedure being performed.

In fact, as will be detailed below, some training procedures are aimed at communications in which the user can express a simple binary decision of selection/non selection of the text element, whereas other training procedures lead to the possibility of formulating messages with more complex mechanisms.

Therefore, the non-verbal action, specifically the action of moving at least one part of the body, can be measured and characterized not only as a function of the simple execution/non-execution of the action itself, but also as a function of a plurality of parameters, including by way of example the range, direction and speed of the movement.

Advantageously, the training procedure can therefore also be uniquely selected according to the specific communication needs of the user and his/her movement abilities.

In fact, it is possible to either carry out simpler and more immediate training procedures if the communication can be resolved with the simple formulation of affirmative or negative answers, or carry out more complex training procedures if it is necessary to provide the user with greater freedom of communication.

In this case too, if the user's needs change over time, it is sufficient to repeat the training procedure by selecting each time the one that best suits the situation.

A possible training procedure is identified for the purposes of this description as a “first training procedure”.

Such a training procedure is performed by associating a first movement condition of at least one part of the body with a communication parameter corresponding to a main command and associating a second movement condition of at least one part of the body (preferably, but not necessarily, the same body part), different from the first movement condition, with a communication parameter corresponding to a secondary command.

Advantageously, the first movement condition can be a condition of immobility of the at least one body part, thus reducing the effort that the user must make for the training and subsequent communication steps.

Such mapping can be calibrated by instructing the user either not to move the body part or to use it in the most convenient manner for him/her while such a body part is monitored with a suitable sensor (which will be discussed further below) and associating the signals detected separately by the sensor with the main command and the secondary command.

In the context defined by such a training procedure, the main command can be a text element selection command and the secondary command can be a text element non-selection command and the delivery of the text content is performed by displaying a succession of distinct text elements.

For each element, the non-verbal action of the user (i.e., movement or non-movement of the body part uniquely associated during training with the main or the secondary command) is acquired for a predetermined time interval, and a decision is made accordingly whether or not to select the corresponding text element.

The method therefore comprises processing the text elements so as to compose a text message by neatly placing the text elements progressively selected by the user side by side.

In other words, a sequence of text elements is shown to the user, and each of them can be either selected by the user by means of the first movement condition which corresponds to the main, selection command or discarded by the user by means of the second movement condition which corresponds to the secondary, non-selection command, until when the message formulation is completed.

Operatively, then, the method is performed by generating a sequence of text elements and measuring an input according to which the elements of interest are selected.

In this context, the text element may preferably comprise letters which are shown sequentially to and individually selected or discarded by the user, until a word or phrase is formed.

The delivery of the text elements can be carried out in a precise and predefined order or can be managed dynamically also according to previously selected text elements.

In other words, the text element delivery order is also defined and/or modified according to the text elements that are progressively placed side by side to form the text message.

Therefore, if the user selects a specific sequence of letters, such a sequence will be taken into account to determine the next letter that will be shown and then subjected to the selection process.

Advantageously, the above-described training mode could also be used to provide different communication modes/methods.

In other words, the training procedure described so far makes it possible to generally define a binary mode of selection of the text elements which can be used in any communication context in which the patient's message can be assembled, defined, or determined as a function of binary interaction with text elements.

Such a binary process can be advantageously associated not only with the selection/non-selection concept but also with the affirmative/negative answer concept.

In other words, the first training procedure can be performed by associating the main command with a communication parameter corresponding to a negative/affirmative answer and associating the secondary command with a communication parameter corresponding to an affirmative/negative answer, respectively.

Therefore, the first training procedure may be alternatively or additionally performed by associating the main command with an affirmative answer.

At the same time, the secondary command is instead associated with a negative answer.

In the context just defined, the text content delivery can be performed by delivering a succession of queries, in particular a succession of closed-ended queries, i.e., queries which can be answered with a binary, yes or no answer.

The non-verbal actions of the user are then acquired for each query, and the answer to this query is determined as being affirmative or negative according to the specific movement performed.

Preferably, the succession of queries defines a decision tree and the order in which the queries are delivered is defined and/or modified according to the acquired input.

In other words, the method is carried out by providing a tree or a network of mutually interconnected queries in which the order of presentation of the queries (and therefore the content of the queries delivered to the user) is determined according to the answers given by the user through non-verbal communication.

Such a procedure is particularly efficient in that it allows the needs of the user or the message he/she wants to communicate to be quickly defined by starting with general questions and progressively narrowing and specifying them until the message that the user wants to transmit or the need, he/she wants to express is identified.

Advantageously, once the end of the sequence of queries has been reached, that is, once the message to be transmitted has been identified, the method may comprise (an aspect which is applicable in general but particularly useful in this context) a verification step in which the user is asked whether or not the conclusion resulting from the decision tree is correct.

A further training procedure is identified for the purposes of this description as a “second training procedure”.

Such a training procedure is performed by displaying a succession of markers in predefined positions on the graphical interface.

Together with the markers, a pointer is also displayed and a movement condition of the at least one body part is associated with a communication parameter corresponding to a pointer movement.

In other words, the movement of the pointer is calibrated by uniquely associating it with a respective movement of the at least one body part.

Specifically, such mapping can be calibrated by instructing the user to move the body part while monitoring it with the sensor and associating the detected movement with the movement of the pointer.

In this context, the acquisition of the non-verbal action is not limited to the discrimination between movement/immobility of the at least one body part but discriminates the specific movement in detail, for example identifying one or more of the parameters described above, with particular attention to the direction and range of the movement.

In the context defined by such a training procedure, the delivery of the text content can be advantageously performed by displaying a plurality of text elements on the graphical interface.

Preferably, a plurality of graphic elements comprising alphanumeric characters arranged to form a keyboard are displayed.

Advantageously, one or more words and/or phrases can also be displayed, preferably next to the keyboard, for example, above it.

These words and/or phrases can also be displayed and therefore suggested to the user according to the alphanumeric characters and/or words previously selected by the user himself/herself, or according to a predefined list.

Operatively, the persistence of the pointer on a text element for a predetermined period of time selects said text element.

In other words, the non-verbal action is acquired when the pointer is moved, and the persistence of the pointer on a certain text element results in the latter being selected.

The method therefore comprises processing the text elements and composing a text message by neatly placing the text elements progressively selected by the user side by side.

Therefore, the method is carried out by allowing the cursor to be moved so as to progressively identify and select the text elements that will be assembled to compose the user's message.

In general, the training procedure described above can also be used for other purposes.

In fact, such a procedure allows the user to associate certain movements that he/she is able to make with corresponding movements of a pointer, thereby allowing him/her to control the operation of any system that can be operated by the movement of such a pointer, not necessarily with the sole purpose of composing a message but also, for example, for controlling one or more functions of the computer by means of which the method described herein is being performed.

Advantageously, the method can also comprise a start-up step which acquires a series of user-related information elements that can be used to control the selection of the specific training procedure, therefore of the communication mode, which is also more efficient when considering the user's clinical picture.

In particular, the start-up step acquires at least one data element relating to the user, preferably such a data element comprises at least one of: age, sex, language, health status, positioning relative to the user of the graphical interface and/or one or more sensors configured or configurable for acquiring non-verbal actions.

In other words, information is acquired both concerning the health status of the user and relating to the system carrying out the method with particular attention to its positioning relative to the user.

Advantageously, the present invention achieves the proposed objects overcoming the drawbacks reported in the prior art by providing the user with a method for non-verbal communication which can be easily and efficiently adapted to the specific needs of the user.

The present invention also relates to a non-verbal communication system specifically configured for the execution of a method having one or more of the technical features described above.

Structurally, such a system comprises a processing and computing unit which defines or contributes to define a computer, or in any case a computer resource configured to perform one or more of the steps of the non-verbal communication method.

Generally, the processing and computing unit is configured to control, command, and manage the operation of the additional components of the system in order to make them operate according to the method.

The system also includes a graphical interface that is configured to display at least the text content and is connected to the processing and computing unit.

Advantageously, the graphical interface can also display further information and graphical contents.

In detail, the graphical interface is defined by a monitor or a portable terminal, for example a smartphone, a tablet, a computer, comprising a screen such as a touch screen.

The system also comprises at least one sensor that can be associated with the at least one part of the user's body to acquire his/her non-verbal actions.

By way of non-limiting example, such a sensor can be or comprise an accelerometric, gyroscopic or magnetic sensor, or the system can comprise a plurality of sensors belonging to the same type or to different types.

Advantageously, the system can be interfaced with a plurality of peripherals which allow the user's communication possibilities to be further optimized.

For example, the system may comprise or be connected via the processing and computing unit with audible and/or optical indicators which can be activated by the user, for example, by means of a selection procedure equivalent to those outlined above through which the text elements are selected.

In other words, the text elements may comprise one or more text elements, the selection of which causes the activation of respective indicators.

In this way, even the user who is unable to communicate verbally can trigger an alarm to alert other people (for example, healthcare professionals) of an emergency situation.

The system can also be interfaced with remote terminals/databases (for example, a computing cloud) to also transmit the messages composed by the user remotely and allow him/her to establish remote communication.

This aspect also allows the collection and storage of data/information that can be analysed later.

The system can also be interfaced with home-automation devices and the text elements can comprise one or more text elements whose selection causes the activation or in any case the control of the operation of one or more of these devices.

1. A computer-executable method for non-verbal communication comprising the steps of:
mapping at least one non-verbal action of a user uniquely associating it with a corresponding communication parameter;
delivering to the user via a graphical interface a text content comprising at least one text element that can be selected;
during the text content delivery, continuously acquiring non-verbal actions of the user and processing at least one text element according to the communication parameter uniquely associated with the acquired non-verbal action.

2. The method according to claim 1, wherein the text elements comprise at least one of: alphanumeric characters, symbols, words, phrases, graphic elements.

3. The method according to claim 1, wherein said mapping step is performed using a training procedure selected from a plurality of training procedures wherein a condition of immobility and/or movement of at least one body part of the user is associated with the respective communication parameter.

4. The method according to claim 3, wherein the plurality of training procedures comprises a first training procedure comprising the following steps:
associating a first movement condition of at least one body part with a communication parameter corresponding to a main command;
associating a second movement condition of the at least one body part, different from the first movement condition, with a communication parameter corresponding to a secondary command.

5. The method according to claim 4, wherein the first movement condition is a condition of immobility of the at least one body part.

6. The method according to claim 4, wherein the main command corresponds to a selection command for the text element and the secondary command corresponds to a non-selection command for the text element; and wherein:
the text content delivery is performed by delivering a succession of distinct text elements;
the step of processing the at least one text element is performed by composing a text message by ordering the text elements progressively selected by the user side by side.

7. The method according to claim 6, wherein the order of text element delivery is also defined and/or modified according to the text elements placed side by side to form the text message.

8. The method according to claim 4, wherein the main command corresponds to an affirmative answer and the secondary command corresponds to a negative answer and wherein the text content delivery is performed by delivering a succession of queries.

9. The method according to claim 8, wherein the succession of queries defines a decision tree and the order in which the queries are delivered is defined and/or modified according to the acquired input.

10. The method according to claim 3, wherein the plurality of training procedures comprises a second training procedure comprising the following steps:
displaying a succession of markers in predefined positions of said graphical interface;
displaying a pointer on said graphical interface;
associating a movement condition of the at least one body part with a communication parameter corresponding to a pointer movement.

11. The method according to claim 10, wherein the text content delivery is performed by displaying a number of text elements on said graphical interface and wherein the persistence of the pointer on a text element for a predetermined time period results in a selection of said text element and the step of processing the at least one text element is performed by composing a text message by neatly placing the text elements progressively selected by the user side by side.

12. The method according to claim 1, comprising a start-up step wherein at least one data element relating to the user is acquired, preferably said at least one data element comprising at least one of: age, sex, language, health status of the user, positioning relative to the user of the graphical interface and/or one or more sensors configured or configurable for acquiring non-verbal actions.

13. A system for non-verbal communication comprising:
a processing and computing unit configured to perform a non-verbal communication method according to claim 1;
a graphical interface configured to display at least the text content;
at least one sensor that can be associated with the at least one part of the user's body to acquire the user's non-verbal actions.
